(19) United States
(12) Patent Application Publication
(10) Pub. No.: US 2013/0170938 A1
(43) Pub. Date: Jul. 4, 2013

(54) APPARATUS AND METHOD FOR ASSISTING THE RETRIEVAL OF IDENTIFICATION OR CREDIT CARDS FROM A WALLET

(71) Applicant: Jennifer Lowden, Las Vegas, NV (US)

(72) Inventor: Jennifer Lowden, Las Vegas, NV (US)

(21) Appl. No.: 13/341,484

(22) Filed: Dec. 30, 2011

(51) Int. Cl. B66F 19/00

(52) U.S. Cl. 414/800; 294/212

(57) ABSTRACT

An apparatus and method for locating and removing a card such as an identification, membership, or banking card from a wallet, purse, or other card holding device. The apparatus includes a flat thin member with a gripping terminus at a first distal end and a coupling implement at a second distal end. The coupling implement is capable of coupling with a card. When coupled to a card that is inserted into the pocket or sleeve of a card holding device the gripping terminus is visible beyond the edge of the card and serves as both a visible indicant of the location of the particular card and an ergonomic and convenient point to grasp and pull to extract the card from the pocket or sleeve.

### FIELD OF THE PRESENT DISCLOSURE

This disclosure relates generally to a location and gripping assistance device and method of use, and more particularly to a unique gripping tab capable of attaching to an identification or credit card to provide an individual with an ergonomic and visually distinct gripping point with which to extract a particular card from the pocket or sleeve of the wallet, purse, or card holding device in which it is located thereby providing a more convenient method of card location and removal.

### BACKGROUND OF THE RELATED ART

An average individual in modern society possesses several plastic or laminated cards. These cards are typically of a standard size and serve a wide variety of purposes including identification, proof of club or association membership, and/or to facilitate financial transactions. Often these cards are carried in a wallet, purse, or other card holding device configured with pockets or sleeves sized to accept such cards leaving only a portion of the cards' edge exposed so that a card may be identified, gripped, and removed from the sleeve or pocket when the individual wishes to present or use that particular card.

While card holding devices are well adapted to provide efficient and organized transportation of a plurality of cards, some individuals find using such devices inconvenient at times. This may be for a variety of reasons including difficulty locating a particular card among the plurality of cards that the individual carries or difficulty removing the particular card from the pocket or sleeve once located.

It is common to design the pockets or sleeves of a card holding device such that when a card is inserted into the pocket or sleeve only a portion of one edge of the card is exposed. Depending on the design of the pocket or sleeve, the exposed edge portion of the card may be very small. To locate a particular card within a card holding device, an individual must be able to recognize the color scheme or pattern of the exposed edge portion of the desired card. This can be challenging if an individual carries several cards with similar or identical color schemes or patterns. This difficulty may be further exacerbated if an individual's eye sight is poor or the lighting conditions are inadequate.

To mitigate these challenges, it is not uncommon for a card holding devices to be designed with multiple pockets or sleeves set forth in a cascading series with each successive pocket oriented slightly below the proceeding pocket or sleeve. This cascade orientation serves to expose a greater portion of each card, thereby assisting the individual to visually locate a particular desired card. It also serves to provide a greater surface area for gripping the particular card that the individual wishes to remove from the pocket or sleeve.

The cascade design, however, does not eliminate difficulty entirely because often times an individual will insert several cards into a single pocket or sleeve. This is common practice when an individual carries more cards than the card carrying device has pockets or sleeves. The cards that are located in the rearward position of each pocket or sleeve have little or no edge portion exposed so an individual has very limited means of locating the cards visually. To locate the rearward situated card an individual must either remember where card is located or systematically empty each pocket or sleeve until the particular desired card is found. Many find this process undesirable because it can be time consuming and/or awkward. There exists a need for an improved method of locating a desired card from within a card holding device, especially rearwardly situated cards.

The practice of placing multiple cards in a single pocket also increases the difficulty of removing a particular card after it is located. When successive cards are inserted into a single pocket or sleeve the fit becomes increasingly tighter thereby increasing the friction force with which the pocket or sleeve holds the cards. This may cause individuals to experience difficulty when attempting to grip the relatively small exposed edge portion of one of the forwardly situated cards and/or cause even greater difficulty when attempting remove one of the rearwardly situated cards without any exposed edge portion available to grip. Therefore, regardless of card position, it is typically more difficult to remove a card from a pocket or sleeve of a card holding device that is stretched tight by multiple cards.

Further, even when the pockets or sleeves are not stretched tight by multiple cards, card removal may still be cumbersome for some individuals. For example, some card holding devices are constructed with smaller pockets or sleeves that create a tight fit for even a single standard sized card.

Individuals with long fingernails often have difficulty removing a card with their finger tips whether the card is rearwardly situated or has an ample edge portion exposed. Similarly, individuals with arthritis in their hands may also experience excessive difficultly with the process of removing a particular card from a pocket or sleeve regardless of the card's position in the card carrying device. For these individuals and others, there exists a need for an ergonomically improved system of removing cards from the pockets or sleeves of typical card holding devices.

The present disclosure distinguishes over the related art providing heretofore unknown advantages as described in the following summary.

### BRIEF SUMMARY OF THE INVENTION

The present disclosure describes an improved method and apparatus for efficiently and conveniently locating and removing identification, membership, and/or banking cards from a card carrying device, such as a wallet, purse, or other card carrying device in which a plurality of cards are carried in pockets or sleeves.

The apparatus comprises a thin flat member featuring a gripping terminus at one distal end and a coupling implement at the opposing distal end. The coupling implement is capable of coupling the presently disclosed apparatus to a particular card in an orientation such that the gripping terminus is extended beyond the edge of the card in a direction away from the pocket or sleeve in which the card is inserted or intended to be inserted. This orientation situates the gripping terminus in a location that is typically more convenient to grip than the edge of the card itself. The length of the apparatus member and the location on the card at which the coupling implement is coupled may be varied to maximize convenience depending on the dimensions and style of the card carrying device.

The presently disclosed apparatus may also feature various ornamentally shaped gripping termini. This feature allows an individual to couple an apparatus with a different visually distinct ornamental gripping terminus to each of several cards the individual carries in his or her wallet, purse, or other card carrying device. The individual may then locate a specific card by locating the visual distinct ornamental gripping terminus that is coupled with that particular card. This method of card location may assist an individual visually locate even a rearwardly located card with relative ease because while the card may be completely or partially hidden from view, the visually distinct ornamental gripping terminus will be visible allowing the individual to locate the card.

The gripping terminus may be visually distinct through its ornamental shape, printed designs or words, or both. In some embodiments the gripping point may feature a logo or trademark. An individual may couple a bank or membership card with an apparatus that features the trademark or logo of the bank or organization that issued the card thereby lessening the burden of remembering which visually distinct ornamental gripping terminus is associated with which card.

The apparatus may be constructed from any material of sufficient tensile strength to withstand the tensile force of pulling a card from a pocket or sleeve. It is preferred that the apparatus be constructed from a material that is generally stiff but allows a moderate degree of flexibility. The stiffness is preferred so that the gripping terminus does not bend or fold over the card and that it stays located in a position that is visually apparent and ergonomically convenient to grip. The flexibility is preferred so that the apparatus does not damage the card it is coupled with or the surrounding cards during the normal motions a typical card carrying device experiences during use. Many plastics exhibit ideal physical characteristic for this purpose.

The width of the apparatus may vary, however, all embodiments should feature a member of a sufficiently thin and flat profile so as to easily fit between cards while situated in the pockets or sleeves of a card carrying device. The gripping terminus should be sufficiently sized to be gripped by an individual using the index finger and a thumb.

This disclosure teaches certain benefits in construction and use which give rise to the objectives described below.

A primary objective inherent in the above described apparatus and method is to increase the convenience of removing a card from the pocket or sleeve of a card holding device.

Another objective of the above described apparatus and method is to increase the convenience of locating a particular card from within a card holding device.

A further objective of the above described apparatus and method is to provide a means of assisting the removal of a card from a card holding device for those who have difficulty with the traditional means of removal.

A still further objective of the above described apparatus and method is to provide an additional mode of self expression by enabling an individual to personalize ones wallet, purse, or other card holding device.

Other features and advantages of the present invention will become apparent from the following more detailed description, taken in conjunction with the accompanying drawings, which illustrate, by way of example, the principles of the presently described apparatus and method of its use.

### BRIEF DESCRIPTION OF THE SEVERAL VIEWS OF THE DRAWING(S)

The accompanying drawings illustrate various exemplary implementations and are part of the specification. The illustrated implementations are proffered for purposes of example not for purposes of limitation. Illustrated elements will be designated by numbers. Once designated, an element will be identified by the identical number throughout. Illustrated in the accompanying drawings is at least one of the best mode embodiments of the present disclosure. In such drawings:

FIG. 1 is a graphical representation of several exemplary embodiments of the presently described apparatus;

FIG. 2 is a exploded view of the presently described apparatus coupled with a typical standard sized card;

FIG. 3 is a non-exploded view of the presently described apparatus coupled with a typical standard sized card;

FIG. 4 is an exemplary view depicting several examples of the presently described apparatus coupled with standard sized cards which are inserted in various pockets and sleeves of a typical wallet style card holding device;

FIG. 5 is an exemplary view depicting several examples of the presently described apparatus coupled with standard sized cards which are inserted in various pockets and sleeves of a typical wallet style card holding device with illustrations of hands demonstrating the card removal method using the apparatus.

### DETAILED DESCRIPTION OF THE EXEMPLARY EMBODIMENT

The above described drawing figures illustrate an exemplary embodiment of an apparatus and method of use in at least one of its preferred, best mode embodiments, which is further defined in detail in the following description. Those having ordinary skill in the art may be able to make alterations and modifications to what is described herein without departing from its spirit and scope of the disclosure. Therefore, it must be understood that what is illustrated is set forth only for the purposes of example and that it should not be taken as a limitation in the scope of the present apparatus and method of use.

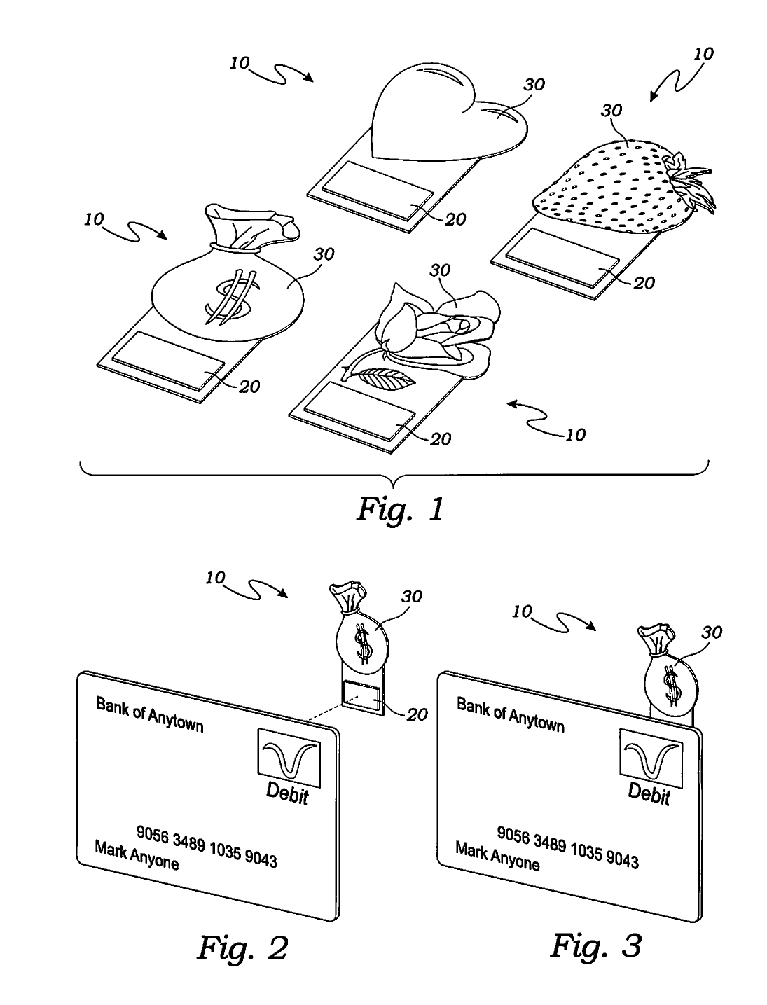

Described now in detail is an apparatus and method of efficiently locating and extracting a card such as an identification, membership, or banking card from a wallet, purse, or other card carrying device. FIG. 1 illustrates a variety of exemplary embodiments of the presently disclosed apparatus 10. Each exemplar apparatus 10 features a coupling implement 20 and a gripping terminus 30. The various gripping termini 30 depicted in FIG. 1 each depict a visually distinct ornamental shape including a heart, a strawberry, a bag of money, and a flower. Though not depicted in FIG. 1 a gripping terminus 30 may also feature trademarks and/or logos. These are merely examples of ornamental shapes and features that a gripping terminus 30 may exhibit. There is no limit to the variety of ornamental gripping termini 30 possible. The wide range of possibilities allow an individual to express themselves through customization and personalization of the look and theme of their card carrying device.

The coupling implement 20 depicted in FIG. 1 may be comprised any material capable of coupling the apparatus 10 to a card with sufficient strength to withstand the shear stress of the force of extraction. In many embodiments the coupling implement 20 is a strip of adhesive. There are several types of adhesive that can serve as a coupling implement 20 for the presently disclosed apparatus 10. Some varieties of adhesives include reactive and non-reactive adhesives. Reactive adhesive create a bond via a chemical reaction with an external factor while non-reactive adhesive form a bond by drying or being pressed against the surface to be bonded as in the case of pressure-sensitive adhesives. Pressure sensitive adhesive can also form either a permanent bond that is not designed to be broken or a removable bond that may be broken and rebonded. The coupling implement 20 may feature any material that can form a bond of sufficient strength including any variety of adhesive.

Each gripping terminus 30, regardless of its ornamental shape, should be sized appropriately to be conveniently gripped by an individual's index finger and thumb. Typically, the width of the gripping terminus 30 is the widest portion of the apparatus 10. However, in some embodiments of the apparatus 10 may feature a wider coupling implements 20 depending strength and nature of the coupling material and bond.

FIG. 2 illustrates the presently disclosed apparatus 10 and a typical bank card in an exploded view demonstrating a preferred orientation of the of the apparatus 10. The gripping terminus 30 is oriented such that it is visible above the edge of the card so that when the card is inserted into a pocket or sleeve the gripping terminus 30 will remain visible. The coupling implement 20 is coupled with the card at the upper edge of the card. If the apparatus was greater in length, the coupling implement 20 may be interfaced with the card a lower location. The primary objective when choosing the location on the card at which the coupling implement 20 will interface the card is the resulting location of the gripping terminus 30 in relation the card's edge.

FIG. 3 illustrates the presently disclosed apparatus 10 and a typical bank card in a non-exploded view. The coupling orientation in FIG. 3 is appropriate for a card that will be inserted into a pocket or sleeve in a landscape orientation so that the gripping terminus 30 will extend out of the pocket or sleeve and remain visible when the card is fully inserted.

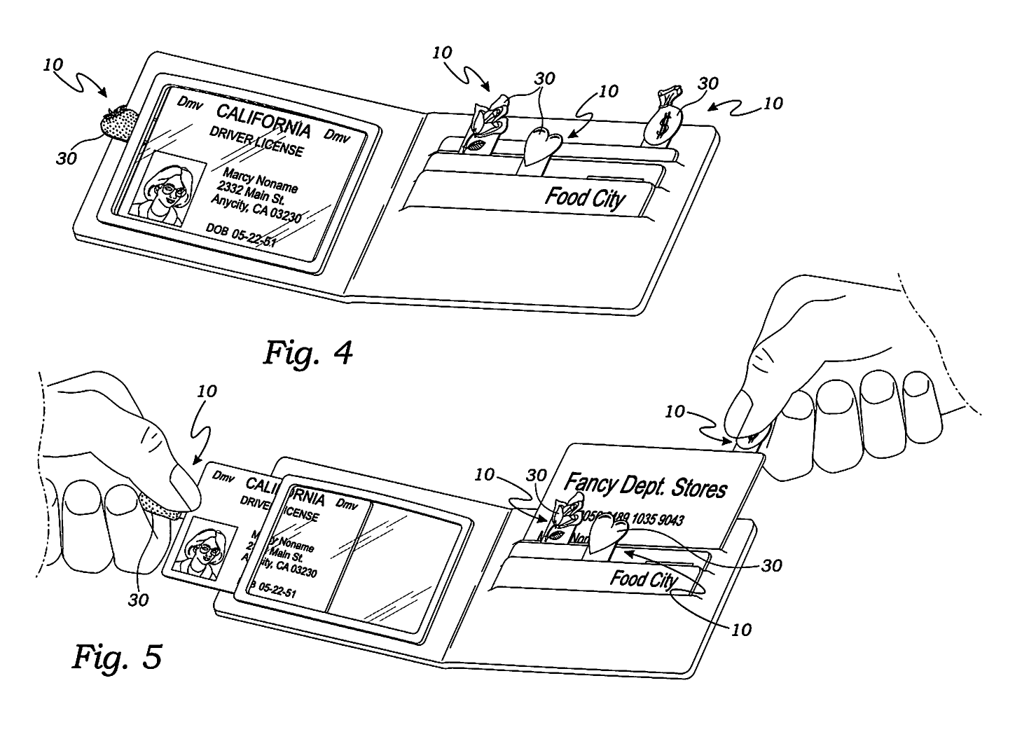

FIG. 4 illustrates a wallet style card holding device with several standard sized cards inserted into its pockets and sleeves. This illustration depicts many of the benefits of the presently disclosed apparatus and method of use. There is an apparatus 10 coupled with the individual's drivers license that features a strawberry shaped gripping terminus 30. The sleeve in which the drivers license card is inserted is deep such that no portion of the cards edge is exposed. While this card may be easily located because the pocket is see-through, it may be difficult to remove the card from the sleeve because the depth of the sleeve. The apparatus 10 featuring the strawberry gripping terminus 30 is coupled with the card such that the strawberry gripping terminus 30 may be easily gripped.

FIG. 4 also illustrates the ease of card location benefit of the presently described apparatus 10 and method. While it may be readily apparent that the card associated with the heart shaped gripping terminus 30 is a membership card to Food City, the two cards behind it are not immediately distinguishable. However, if the individual can remember that the money bag shaped gripping terminus 30 is associated with the Fancy Department Store card (as shown in FIG. 5) then the card may be visually located with ease.

FIG. 4 illustrates the ergonomic and convenient removal of cards from a wallet style card carrying device using the presently disclosed apparatus 10 and method. One human hand in FIG. 4 is depicted gripping the strawberry shaped gripping terminus 30 between the index finger and thumb. The individual may then easily extract the driver's license card from the sleeve by gently pulling the gripping terminus 30 in the desired direction. The other human hand depicted in FIG. 4 is gripping a gripping terminus 30 shaped like a bag of money and extracting the Fancy Department Store card with the same convenient grip and motion.

The enablements described in detail above are considered novel over the prior art of record and are considered critical to the operation of at least one aspect of the apparatus and its method of use, and to the achievement of the above-described objectives. The words used in this specification to describe the instant embodiments are to be understood not only in the sense of their commonly defined meanings, but to include by special definition in this specification: structure, material, or acts beyond the scope of the commonly defined meanings. Thus, if an element can be understood in the context of this specification as including more than one meaning, then its use must be understood as being generic to all possible meanings supported by the specification and by the word(s) describing the element.

The definitions of the words or drawing elements described herein are meant to include not only the combination of elements which are literally set forth, but all equivalent structures, materials or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, substitutions, now or later known to one with ordinary skill in the art, are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that the named inventor believes that the claimed subject matter is what is intended to be patented.

What is claimed is:

1. An apparatus for locating and removing a card from the pocket or sleeve of a card carrying device, the apparatus comprising:
a flat member having an anterior and posterior side, a first and a second distal end, and a middle length there between;
a gripping terminus located at said first distal end, said gripping terminus sized to accommodate gripping by an individual's index finger and thumb;
a coupling implement located at said second distal end, said coupling implement for coupling said apparatus to a card.

2. An apparatus as in claim 1, wherein said coupling implement is located on the anterior side of the second distal end of the member.

3. An apparatus as in claim 2, wherein said coupling implement comprises a strip of non-reactive adhesive capable of coupling said apparatus with a card.

3. An apparatus as in claim 2, wherein said coupling implement comprises a strip of reactive adhesive capable of coupling said apparatus with a card.

4. An apparatus as in claim 2, wherein said coupling implement comprises a strip of pressure-sensitive adhesive capable of detachably coupling said apparatus with a card.

5. An apparatus as in claim 2, wherein said coupling implement comprises a strip of pressure-sensitive adhesive capable of permanently coupling said apparatus with a card.

6. An apparatus as in claim 2, wherein said member is constructed from a flexible plastic material.

7. An apparatus in claim 6, wherein said gripping terminus is ornamentally shaped and of a greater width than that of the middle length.

8. An apparatus as in claim 7, wherein said gripping terminus features printed matter such as a trademark or logo.

9. A method of locating and removing a card from a card carrying device using the presently claimed apparatus, method comprising the steps of:
1) coupling the coupling implement of the presently claimed apparatus with the anterior of a desired card such that the gripping terminus is located beyond the edge of a card;
2) inserting the card in a pocket or sleeve of a card holding device such that the gripping terminus is visible when the card is fully inserted;
3) visually locating the gripping terminus of the presently described apparatus;
4) gripping the gripping terminus of the presently claimed apparatus with your index finger and thumb;
5) pulling the gripping terminus of the presently claimed apparatus until the card is extracted from the pocket or sleeve of the card holding device.

10. A method as in claim 9, further comprising the step of allowing the reagent in the coupling implement to cure prior to inserting the card in a pocket or sleeve of a card holding device.
